(19) United States
(12) Patent Application Publication
(10) Pub. No.: US 2003/0194608 A1
(43) Pub. Date: Oct. 16, 2003

(54) Copper member for battery

(76) Inventors: Yuichi Hirai, Tokyo-to (JP); Rikiya Yamashita, Tokyo-to (JP); Kazuki Yamada, Tokyo-to (JP); Masataka Okushita, Tokyo-to (JP)

Correspondence Address: Richard J. Streit, Ladas & Parry, Suite 1200, 224 South Michigan Avenue, Chicago, IL, 60604, US

(21) Appl. No.: 10/360,909

(22) Filed: Feb. 7, 2003

(30) Foreign Application Priority Data
Feb. 20, 2002 (JP) P2002-043889

(51) Int. Cl. H01M 2/30

(52) U.S. Cl. 429/178

(57) ABSTRACT

The present invention provides a copper member having a high adhesion stability, free from corrosion caused by hydrofluoric acid generated from the electrolyte of the battery terminal and water. A composite covering layer of an aminated phenol phenol polymer, a trivalent chromium compound and a phosphorus compound on the surface of a foil-shaped or sheet-shaped copper member. The composite covering layer has an aminated phenol polymer deposit weight from 1 to 200 mg/m², a chromium deposit weight from 0.5 to 50 mg/m², and a phosphorus deposit weight of 0.5 to 5 mg/m².

### BACKGROUND OF THE INVENTION

1. Field of the Invention

The present invention relates to a battery comprising a copper member exhibiting a stable sealing property with a packaging material, battery tabs comprising the copper member, and a battery packaging material which packages the tabs and a battery main body.

2. Description of the Related Art

The term “battery” as used in the present invention means a battery including elements which convert chemical energy into electric energy such as a lithium-ion battery, a lithium battery, or a fuel battery, or an electrolytic condenser such as a liquid condenser, a solid condenser or a double-layer condenser containing a dielectric such as a liquid or solid ceramics or an organic material.

Uses of a battery include personal computers, portable terminal units (battery phones, PDAs, etc.), video cameras, battery cars, energy-storing batterys, robots or artificial satellites.

A metal can made by press-working a metal into a cylindrical or rectangular parallelepiped container, or forming a laminate into a bag-shaped article comprising a composite film resulting from lamination of a plastic film or metal foil has conventionally been used as an outer shell of the above-mentioned lithium-ion battery (hereinafter referred to as an “outer shell”).

The following problem is however encountered as to the outer shell of a battery. In a metal can, having a rigid container outer shell, the shape of battery itself is limited. It is therefore necessary to design hardware in response to the battery, resulting in dependency of the hardware size using the battery upon the battery conditions, and hence in a lower degree of freedom of the shape.

It is therefore a general tendency to use the above-mentioned bag-shaped outer shell. The outer shell comprises at least a base layer, a barrier layer, a sealant layer and a bonding layer which bonds these layers, taking into account physical properties, workability and economic merits necessary as a battery, an intermediate layer may be provided as required.

A pouch is formed from the laminate having the above-mentioned configuration of the battery, or at least one side is press-formed into a housing section of the battery to house therein the main body of the battery. A battery is completed by heat-sealing necessary peripheral portions in the thus formed pouch-type or emboss-type (covered with a lid) housing section.

The main body of the battery comprises a battery module, and positive and negative tabs for taking out current from the battery section. Upon sealing the outer shell housing therein the battery main body, tabs made of copper members held between heat seal sections of the outer shell are heat-sealed with an innermost layer of the outer shell or with an adhesive film and the assembly is hermetically sealed as a battery.

When forming at least one of the tabs from a copper member as described above, inserting the battery main body having such a terminal into the outer shell, hermetically sealing the same and storing the same for a long period of time, the tabs surface may be corroded by hydrogen fluoride produced from a reaction between the electrolyte of the battery and water at a portion of the terminal made of the copper member at the heat sealing section, resulting in peeling of the heat sealing section.

An object of the present invention is to provide a copper member having a satisfactory bonding stability, free from corrosion caused by hydrofluoric acid produced by the electrolyte of the battery terminal and water.

### SUMMARY OF THE INVENTION

The aforementioned problems can be solved by the present invention as follows.

A first aspect of the present invention provides a copper member for battery, having a composite covering layer comprising an aminated phenol polymer, a trivalent chromium compound and a phosphorus compound formed on the surface of a foil-shaped, sheet-shaped or plate-shaped copper member.

A second aspect of the present invention provides a copper member for battery according to the first aspect of the invention, wherein the composite covering layer has an aminated phenol polymer deposit weight from 1 to 20 mg/m², a chromium deposit weight from 0.5 to 50 mg/m², and a phosphorus deposit weight from 0.5 to 5 mg/m².

A third aspect of the present invention provides a copper member for battery according to the first aspect of the invention, wherein an alkaline degreasing treatment is applied to the surface of the copper member prior to forming the composite covering layer.

A fourth aspect of the present invention provides a copper member for battery according to the first aspect of the invention, wherein a pickling treatment is applied to the surface of the copper member prior to forming the composite covering layer.

A fifth aspect of the present invention provides a copper member for battery according to the first aspect of the invention, an alkaline degreasing treatment and a pickling treatment are applied to the surface of the copper member prior to forming the composite covering layer.

A sixth aspect of the present invention provides a battery terminal comprising a copper member according to the first aspect of the invention.

A seventh aspect of the present invention provides a battery, wherein at least one terminal is a battery terminal according to the sixth aspect of the invention, having the battery and a battery packaging material for packaging a main body of the battery.

### BRIEF DESCRIPTION OF THE DRAWINGS

FIG. 1 illustrates examples in which the copper member for battery of the present invention is used as a terminal: (a) is a perspective view of the battery main body; (b) is a sectional view cut along the line X₁-X₁; and (c) is an enlarged view of the Y1 portion;

FIG. 2 is a view illustrating a battery main body using the copper member for battery of the present invention as a terminal, and packaging by the outer shell thereof: (a) is a perspective view of the battery main body; (b) is a perspective view of the battery main body in which an adhesive film is temporarily deposited onto the tabs section; (c) is a perspective view of a hermetically packaged battery; (d) is a sectional view cut along the line X₂-X₂; and (e) is a sectional view cut along the line X₃-X₃;

FIG. 3 is a sectional view illustrating an example of the laminate forming a packaging material: (a) shows a composite covering layer provided on a single side of the copper foil; and (b) shows composite covering layers provided on both sides of the copper foil;

FIG. 4 is a perspective view illustrating the pouch type outer shell of the battery;

FIG. 5 is a perspective view illustrating the emboss-type outer shell of the battery; and

FIG. 6 is a perspective view illustrating a bonding method of an adhesive film upon bonding the packaging material for battery and the terminal.

### REFERENCE NUMERALS IN THE DRAWINGS

1: Battery, 2: Battery main body, 3: Battery module (energy-stating section), 4: Tab (Terminal), 4M: Copper member, 4R: Composite covering layer, 5: Outer shell, 5h: Heat sealing section, 5fh: Fin sealing section, 6: Adhesive film, 7: Concavity, 8: Side wall, 9: Flange portion, 10: Laminate forming an outer shell, 11: Base material layer, 12: Barrier layer, 12S: Chemical treatment layer, 13: Bonding layer, 13d: Dry laminate layer, 13e: Bonding resin layer, 14: Heat sealing layer.

### DESCRIPTION OF THE PREFERRED EMBODIMENTS

The present invention provides a technique of using a copper member excellent in corrosion resistance as at least one terminal of a battery when using a foil-shaped, sheet-shaped or plate-shaped copper member as such a terminal. The present invention will be described in detail as to a case of a copper foil or a copper sheet with reference to the drawings regarding a lithium-ion battery.

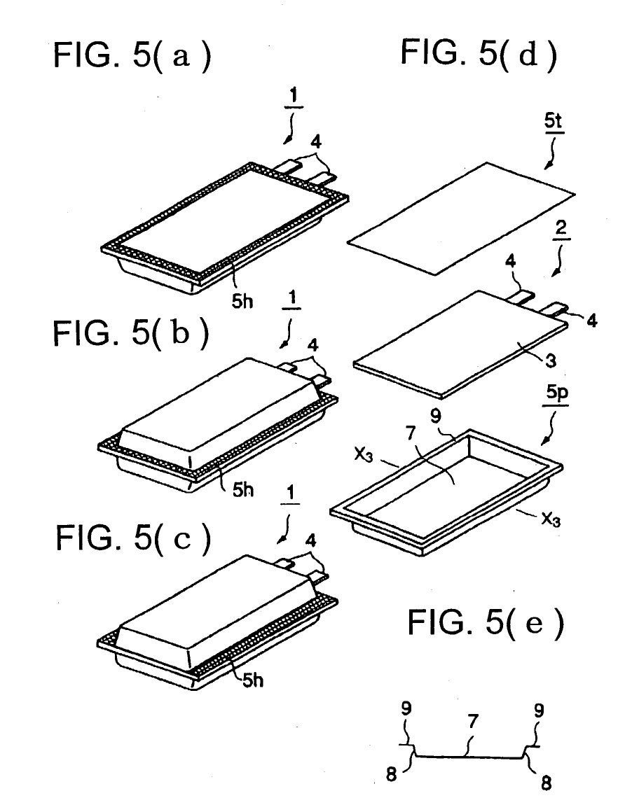

Lithium-ion batterys are broadly classified in terms of the type of the outer shell packaging the lithium-ion battery main body into a pouch-type one as shown in FIG. 4 and an emboss-type one as shown in FIG. 5. The present invention is applicable to any of these types.

Moisture-proofing property is imparted to a lithium-ion battery main body 2 housed in an outer shell 5 by hermetically sealing the peripheral edge thereof. The tabs section made of a metal is heat-sealed with a metal bonding film of an innermost layer 14 of a packaging material for lithium-ion battery.

The above-mentioned innermost layer 14 may be made of a material not having heat-sealing property with a metal. In this case, however, the terminal and the innermost layer are heat-sealed via an adhesive film 6 having heat-sealing property both with the metal terminal and with the innermost layer of the packaging material for lithium-ion battery.

The terminal 4, being made of a metal, may suffer from surface corrosion caused by hydrogen fluoride (HF) produced in the electrolyte contained therein, resulting in peeling between the terminal 4 and the resin layer bonded thereto, and hence in leakage of the electrolyte.

The terminal of the lithium-ion battery has a thickness from 8 μm to 5 mm, a width from 4 to 20 mm, and is made of aluminum (Al), copper (Cu) (including nickel-plated Cu) or nickel (Ni).

From among these terminal materials, nickel is hardly susceptible to the risk of being corroded by hydrofluoric acid. Aluminum has a problem of most easily being corroded, so that various corrosion preventing treatments are applied. While copper had been considered to be hardly exposed to the risk of being corroded, there was actually the risk of suffering from corrosion, as in aluminum, caused by hydrofluoric acid generated from the reaction between the electrolyte of the lithium-ion battery and water during service for a long period of time, leading to loss of sealing property resulting from peeling at the bonding surface with the packaging material.

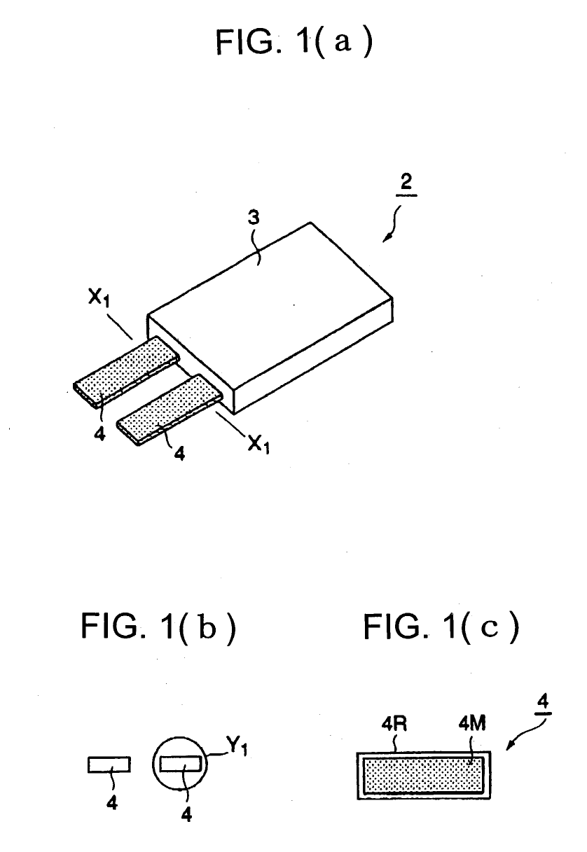

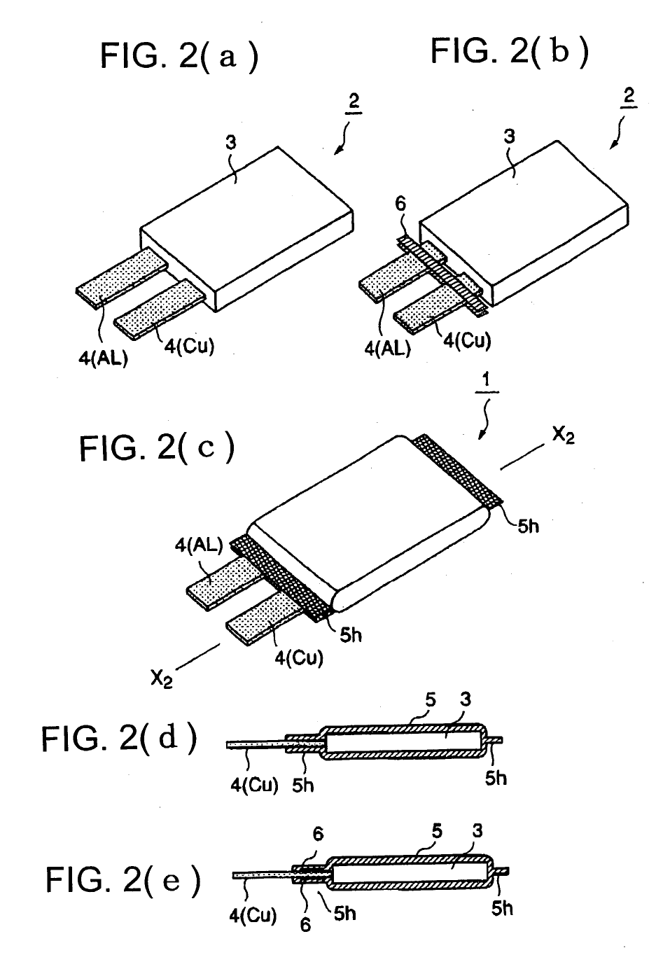

When forming a composite covering layer on the terminal comprising a copper member, in the present invention, the composite covering layer is formed after applying a pretreatment based on any of methods described later to the surface of the copper member (copper sheet) having an applicable loop sectional shape or cut into a prescribed length. In a state in which composite covering layers are formed on the copper member, as shown in FIG. 1(c), the composite covering layers 4R are formed on the surface and back sides and the flank of the terminal material 4M surface, at least at positions to be heat-sealed by the outer shell.

The surface of copper foil or a copper sheet often has deposited oil or a copper oxide formed thereon. Forming a composite covering layer in this state, in the case of a copper sheet terminal, leads to unstable adhesion with the adhesive film, or with a metal bonding resin layer serving as an innermost layer of the outer shell. As a result, the terminal and the bonding resin portion with the terminal portion may be peeled off during storage for a long period of time. To avoid this inconvenience, it is possible to prevent such peeling or delamination by forming composite covering layers on the surface of the copper member, or by carrying out various pretreatments as described below prior to forming the composite covering layers 4R.

As a pretreatment, an acidic substance may be used. More specifically, applicable substances include inorganic acids such as hydrochloric acid, sulfuric acid, nitric acid, chromic acid, dichromic acid, hydrofluoric acid, phosphoric acid, and sulfonic acid; citric acid, gluconic acid, oxalic acid, tartaric acid, formic acid, hydroxyacetic acid, EDTA (ethylenediamine tetracetic acid), and derivatives thereof; and ammonium thioglycolate. Particularly, dichromic acid may most preferably be used.

As a pretreatment, an alkaline substance may be used. More specifically, applicable alkaline substances include caustic soda (NaOH), soda ash (Na₂CO₃), sodium bicarbonate (NaHCO₃), sodium sulfate (Na₂SO₄.1OH2O), sesqui-sodium carbonate (Na₂CO₃.NaHCO₃.2H₂O), and other soda salts; silicates such as sodium orthosilicate (2Na₂O.SiO₂, water content: 10 to 40%), sodium methasilicate (2Na₂O.SiO₂.9H₂O), No. 1 sodium silicate (Na₂O.2SiO₂, water content: 42 to 44%), No. 2 sodium silicate (Na₂O.3SiO₂, water content: 65%), monobasic sodium phosphate (NaH₂PO₄), sodium pyrophosphate (Na₄P₂O₁₇), sodium hydrogenphosphate (Na₂HPO₁₄), soda hexamethanate {(NaPO₃)₆}, trisodium phosphate (Na₃PO₄), sodium tripolyphosphate (Na₆P₃O₁₀) and other phosphates.

As treatments to be carried out prior to forming the composite covering layers on the surface of the copper foil or the copper sheet, it is desirable to ensure formation of the composite covering layers on the surface of the copper foil or the copper sheet through alkaline degreasing, water rinsing, then pickling and water rinsing. The aforementioned substances may be used as alkalis and acids in these treatments.

The pretreatment applied prior to forming the composite covering layers comprises the steps of providing an aqueous solution of the above-mentioned acid or alkali, dipping the copper foil or the copper sheet into the aqueous solution, or coating the aqueous solution onto the surface of the copper foil or the copper sheet by spraying or by roll coating, and then drying the copper surface after cleaning the same by water rinsing, thereby immediately forming the composite covering layers.

The composite covering layer is provided for the purpose of firmly bonding the copper member such as the copper foil or the copper sheet and the metal bonding resin, and protecting the surface of the copper member from the electrolyte or hydrofluoric acid generated from hydrolysis of the electrolyte. The composite covering layer is a reaction product of an aminated phenol polymer, a trivalent chromium compound and a phosphorus compound, having a deposit weight of the aminated phenol polymer within a range from 1 to 200 mg/m², a deposit weight of chromium within a range from 0.5 to 50 mg/m², and a deposit weight of phosphorus within a range from 0.5 to 5 mg/m². These three constituents are closely formed into a covalent bond or a coordinate bond based on cross-linking reactions, and are firmly deposited through reaction with the copper surface.

In addition, the composite covering layer is hardly soluble in water, an aqueous acidic solution containing an acid constituent such as hydrofluoric acid, and an organic solvent, and exhibits an excellent durability. It is therefore excellent in corrosion resistance against a gel-type electrolyte even after deterioration thereof, permitting maintenance of satisfactory adhesion with an olefinic thermo-bonding resin layer.

When the deposit weights of the three constituents of the composite covering layer are outside the prescribed ranges, the following inconveniences in performance or economic merits may be caused. More specifically, when the deposit weight of aminated phenol polymer of the composite covering layer becomes under 1 mg/m², it is impossible to cover the entire surface of the copper foil. Corrosion resistance against hydrofluoric acid resulting from deterioration or hydrolysis of the gel-type electrolyte cannot display its full merits, and a deposit weight over 200 mg/m² may lead to a poorer adhesion.

A deposit weight of chromium under 0.5 mg/m² cannot give a sufficient corrosion resistance. A deposit weight over 50 mg/m² is not economically desirable because a further improvement of corrosion resistance is unavailable. A deposit weight of phosphorus under 0.5 mg/m² leads to a lower adhesion (interlayer bonding strength) under the effect of the electrolyte. A deposit weight of phosphorus over 5 mg/m², on the other hand, results in an excessive amount of phosphorus compound, which makes the composite covering layer more brittle, leading to a poorer adhesion (interlayer bonding strength) under the effect of the electrolyte.

The composite covering layer can be formed by coating a water-soluble treatment agent containing an aminated phenol polymer, a trivalent chromium compound and a phosphorus compound onto the copper foil surface by a coating method described later, and then, heating and drying the same.

The chemical composition of the above-mentioned water-soluble treatment agent and the method for forming the composite covering layer will now be described in detail.

The aminated phenol polymer is expressed by the following chemical formula (1):

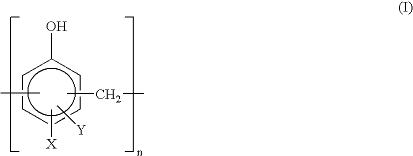

[where, X combined with the benzene ring in formula (1) is one or more selected from the group consisting of hydrogen atom, hydroxyl group, alkyl group, or hydroxyalkyl group, allyl group, benzyl group, benzal group, or unsaturated hydrocarbon group forming a naphthalene ring in condensation with the above-mentioned benzene ring.]

Y combined with the benzene ring in formula (1) above is expressed by the following chemical formula (2):

—CH₂—NR₁R₂ (2)

[where, R₁ and R₂ in formula (2) are independent of each other, and represent hydroxyl group, alkyl group, or hydroxyalkyl group; the average value of introducing ratio of Y, i.e., the substitution number is within a range from 0.2 to 1.0 relative to n in formula (1); and n is an average degree of polymerization within a range from 2 to 50.]

The aminated phenol polymer contained in the above-mentioned water-soluble treatment agent is obtained by polycondensing a phenol polymer, a naphthol compound and formaldehyde, and introducing a water-soluble functional group by use of formaldehyde and amine. The aminated phenol polymer should preferably have a molecular weight as represented by a number average molecular weight within a range from about 5 to one million, or more preferably, from 1,000 to 20,000.

Applicable trivalent chromium compounds to be contained in the water-soluble treatment agent include, for example, chromium nitrate, chromium fluoride, chromium sulfate, chromium acetate, and chromium oxalate. Applicable phosphorus compounds to be contained in the water soluble treatment agent include phosphoric acid, condensed phosphoric acid, and salts thereof, and applicable such salts include ammonium salt, and alkali metal salts such as sodium salt and potassium salt.

The aforementioned water-soluble treatment agent should exhibit an acidity as represented by a pH under 6. Applicable pH adjusting agents include phosphoric acid, nitric acid, sulfuric acid, succinic acid, malic acid, citric acid and salts thereof. Such salts include ammonium salt, and alkali metal salts such as sodium salt and potassium salt.

The composite covering layer can be formed by coating the above-mentioned water-soluble treatment agent by any of the known coating methods such as the dipping method, the bar coating method, the roll coating method, the spin coating method and the spraying method, and then drying the agent by heating. Applicable energy sources for heating and drying include gases, electricity and infrared rays. Drying by heating is carried out for the purpose of evaporating water contained in the water-soluble treatment agent, and accelerating the reaction of the phenol polymer, the chromium compound and the phosphorus compound, thereby making the resultant composite covering layer insoluble. The heating/drying temperature should appropriately reach an ultimate temperature within a range from 80 to 300° C. or more preferably, from about 120 to 250° C.

The coating weight of the film in dry should preferably be about 10 mg/m².

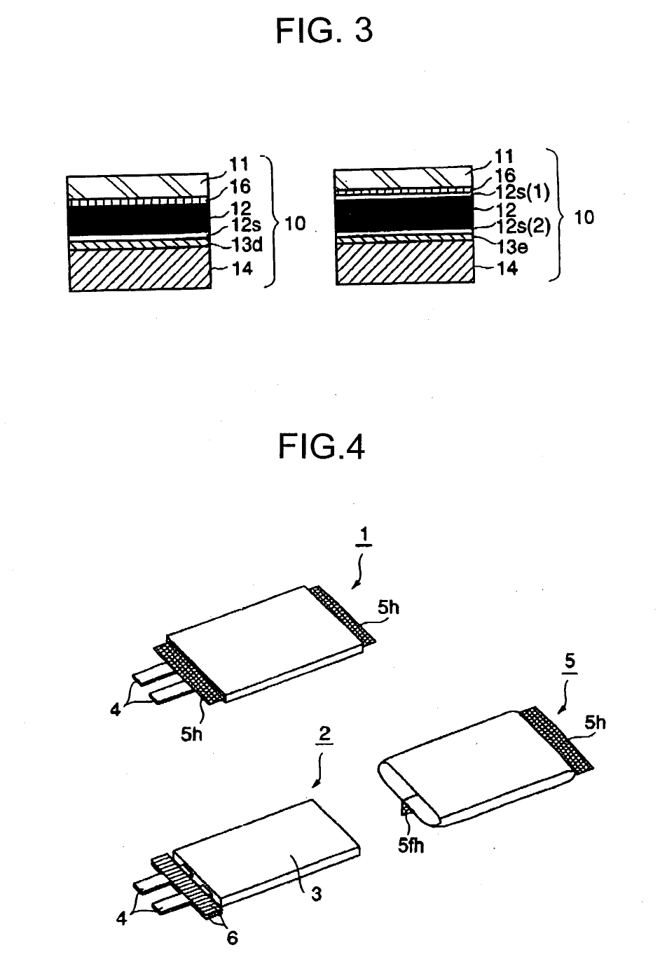

The laminate 10 forming the outer shell 5 in a case where the battery copper member of the present invention is used for at least one terminal 4 of the battery will be described. The laminate 10 comprises at least a base material layer 11, a barrier layer 12 and a heat sealing layer 14 as shown in FIG. 3(a). The barrier layer 12 and the heat sealing layer 14 may be laminated by the dry laminating method 13d, or, as shown in FIG. 3(b), the barrier layer 12 and the heat sealing layer 14 may be laminated by any of the sandwich laminating method, the extrusion laminating method and the heat laminating method 13e.

The outermost layer 11 comprises a drawn polyester or nylon film. Applicable polyester resins include polyethylene terephthalate, polybutylene terephthalate, polyethylene naphthalate, polybutylene naphthalate, copolymerized polyester, and polycarbonate. Applicable nylon resins include polyamide-based resins such as nylon 6, nylon, 6,6, copolymer of nylon 6,6 and nylon 6, nylon 6,10, and polymethaxylylene adipamide (MXD6).

When using in a lithium-ion battery, the outermost layer 11 should preferably be a resin layer having basically insulating property since the layer is at a portion in direct contact with the hardware. Considering the presence of pinholes in the film alone and the generation of pinholes during working, the outermost layer should have a thickness of at least 6 μm, or more preferably, within a range from 12 to 25 μm.

In order to improve the pinhole resistance and the insulating property when serving as an outer shell of a battery, the outermost layer 11 may have a laminated configuration.

When laminating the outermost layer 11, the outermost layer should include at least one of two or more resin layers, each of such resin layers having a thickness of at least 6 μm, or preferably, within a range from 12 to 25 μm. Example of lamination of the outermost layer include the following 1) to 7), although not shown:

1) Oriented polyethylene terephthalate/drawn nylon;

2) Oriented nylon/ drawn-drawn polyethylene terephthalate;

It is desirable to convert the outermost layer into a multi-layer structure, and provide a fluorine-based resin layer, an acryl-based resin layer, a silicone-based resin layer and the like on the surface of the outermost layer for the purpose of imparting mechanical properties of the packaging material (conveyance stability in packaging and working machines), and surface protecting properties (heat resistance, and electrolyte resistance), and reducing frictional resistance between the die for embossing and the outermost layer upon achieving an emboss-type outer shell for a lithium-ion battery as a secondary working. For example:

3) A fluorine-based resin/oriented polyethylene terephthalate (the fluorine-based resin is formed by using a film-shaped material or coating a liquid material and then drying);

4) A silicone-based resin/oriented polyethylene terephthalate (the silicone-based resin is formed by using a film-shaped material or coating a liquid material and then drying);

5) A fluorine-based resin/oriented polyethylene terephthalate/oriented nylon;

6) A silicone-based resin/oriented polyethylene terephthalate/oriented nylon;

7) An acryl-based resin/oriented nylon (the acryl-based resin is formed by using a film-shaped material or coating a liquid material and then drying for curing).

Applicable methods for lamination of the laminate 10 of the packaging material for a lithium-ion battery include the dry laminating method, the heat laminating method, the extrusion laminating method, the sandwich laminating method, and the co-extrusion laminating method.

The barrier layer 12 in the battery packaging material serves to prevent inflow of steam or the like into the lithium-ion battery from outside through the outer shell. For the purpose of stabilizing pinholes and workability (pouch forming, emboss forming) and imparting pinhole resistance of the barrier layer alone, applicable layers include a layer of a metal such as aluminum or nickel, or a film having a deposited inorganic compound such as silicon oxide or alumina having a thickness of at least 15 μm. The barrier layer should preferably be aluminum foil having a thickness from 20 to 80 μm.

When using aluminum foil as a barrier layer 12, a laminate satisfactory as an outer shell is available by applying a chemical treatment at least to a laminated surface side with the sealant of the aluminum foil. More specifically, dissolution and corrosion of the aluminum surface caused by hydrogen fluoride generated from reaction between electrolyte of the battery and water by forming an acid-resistant film 12S comprising a phosphate, a chromate, a fluoride or a triazinethiol compound.

FIG. 3(a) illustrates an example in which a chemical treatment layer 12S is provided on the sealant layer side of the barrier layer, and FIG. 3(b) shows an example in which chemical treatment layers 12S(1) and 12S(2) are provided on both sides of the barrier layer.

The innermost layers 14 of the outer shell 5 packaging the battery main body 2 having a terminal 4 (Cu) comprising a copper member for battery of the present invention are heat-sealable with each other and with the metal which forms the tabs including the above-mentioned terminal 4 (Cu) comprising the copper member. The innermost layer 14 should be made of a material free from deterioration or degradation, depending upon the contents. As a result of search for such a material, a satisfactory result was found to be obtained from a material having a thickness of at least 10 μm, or preferably within a range from 20 to 100 μm, a melting point of at least 80° C., a Vicat softening point of 70° C. or higher, containing at least one selected from the group consisting of unsaturated graft olefin carboxylate resins such as unsaturated graft polyethylene carboxylate, unsaturated graft propylele carboxylate, and unsaturated graft polymethylpentene carboxylate, metal ion cross-linking polyethylene, and polyethylene and a copolymer of propylene and acrylic acid or methacrylic acid, and denatured products thereof.

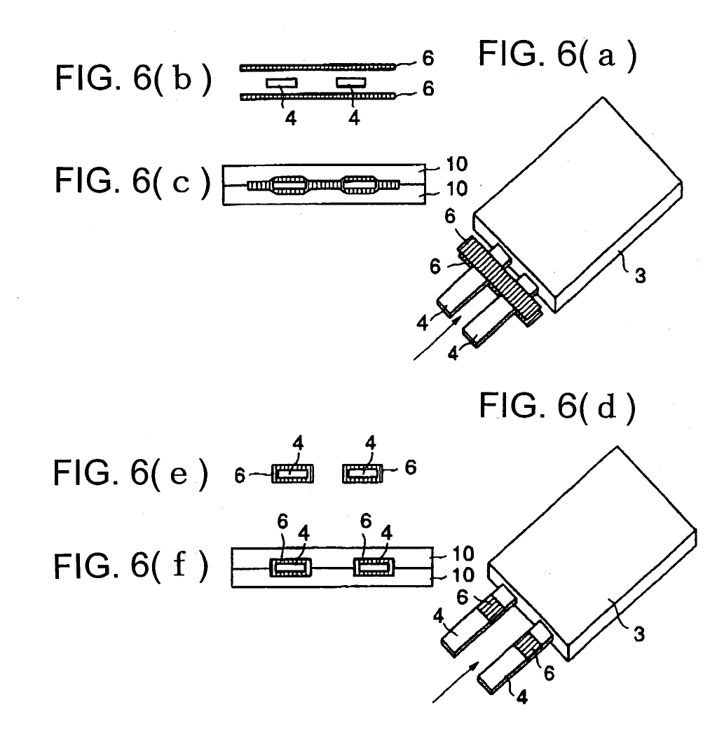

Polyolefin or the like not having adhesion to a metal may be used for the innermost layer 14. In this case, as shown in FIG. 6, the terminal 4 is completely bonded to the outer shell 5 by using, between the electrode 4 and the outer shell 10 (actually the innermost layer 14), an adhesive film (thickness of at least 15 μm) formed of unsaturated graft polyolefin carboxylate, metal cross-linking polyethylene, a copolymer of ethylene or propylene with acrylic acid or methacrylic acid, thereby permitting ensuring tight sealing.

The setting method of the adhesive film 6 to the tabs section 4 may comprise, as shown in FIGS. 6(a) to 6(c), the step of providing an adhesive film 6 sealable both to the metal and the heat sealing layer between the terminal 4 and the heat sealing layer 14, or, as shown in FIGS. 6(d) to 6(f), the step of winding the adhesive film 6 at a prescribed position around the terminal 4.

For the above-mentioned adhesive film 6, applicable materials include unsaturated graft denatured polyolefin carboxylate, metal cross-linking polyethylene, a co-polymer of ethylene or propylene with acrylic acid or with methacrylic acid.

The innermost layer 14 in the laminate of the present invention may be a single layer comprising the above-mentioned resin, or may be two or more layers containing the above-mentioned resin.

The above-mentioned unsaturated graft denatured polyolefin carboxylate resins are satisfactory in any of adhesion to the electrode, heat resistance, cold resistance, and workability (pouch formability, emboss formability). When the innermost layer has a thickness under 20 μm, a gap is produced at an end portion upon heat-sealing the electrode, and this causes the barrier property to disappear. Even when the thickness of the innermost layer exceeds 100 μm, heat sealing intensity shows no change, thus increasing the thickness of a laminate. This is contrary to the merit of space saving of the present invention, since the heat sealing intensity does not change, and there is an increase in thickness of the laminate.

When the melting point and the Vicat softening point are low, heat resistance and cold resistance become null. Adhesion between the films and between the films and the electrode decreases, resulting in breakage of the films. The unsaturated graft denatured carboxylate polymer may be used singly independently of each other, or property requirements may be satisfied by using two or more resins in blend.

For the purpose of appropriately improving film-formability, laminability, and final product secondary workability (pouching and emboss formability), the individual layers of the laminate of the present invention may be subjected to a surfactant treatments such as a corona treatment, a blasting treatment, an oxidizing treatment, or an ozone treatment.

In the battery using a copper member for battery of the present invention, an outermost layer 11, a barrier layer 12, and an innermost layer 14 of the laminate 10 used in the outer shell 5 can be formed specifically by any of the T-die method, the inflation method, and the co-extruding method. A secondary film may be formed or each layer may be formed by any of such methods as coating, vapor deposition, ultraviolet-ray curing and electron beam curing as required.

Applicable cladding methods include the dry laminating method, the extrusion laminating method, the co-extrusion laminating method, and the thermal laminating method.

When conducting cladding by the above-mentioned dry laminating method, any of the following adhesives may be used. Applicable adhesives include polyester-based, polyethyleneimine-based, polyether-based, cyanoacrylate-based, urethane-based, organic titanium-based, polyetherethane-based, epoxy-based, polyesterurethane-based, imide-based, isocyanate-based, polyolefin-based, and silicone-based adhesives.

Chemical resistance and organic solvent resistant can further be improved by adding an additive containing at least one of silicon oxide, calcium carbonate, zinc, minium (red lead), lead monoxide, lead oxide, lead cyanimide, zinc chromate, barium-potassium chromate, and barium-zinc. chromate, appropriately to these adhesive layers. Among others, silicon oxide, calcium carbonate, zinc, minium (red lead), lead monoxide, zinc oxide, lead cyanamide, zinc chromate, barium-potassium chromate and barium-zinc chromate have a function of absorbing and adsorbing hydrogen fluoride generated from the reaction between electrolyte and water, and of preventing corrosion of the layers, particularly the barrier layer (aluminum) by hydrogen fluoride.

When using the above-mentioned extrusion laminating method, adhesion between the layers may be promoted by coating, into a thickness of about 1 μm, one or more of polyester-based, polyether-based, urethane-based, polyetherurethane-based, polyesterurethane-based, isocyanate-based, polyolefin-based, polyethyleneimine-based, cyanoallylate-based, organic titanium compound-based, epoxy-based, imide-based, and silicone-based resins, denatured products thereof, or a mixture thereof, or applying a surfactant treatment through an ozone treatment.

When performing cladding by the above-mentioned extrusion laminating method or the thermal laminating method, adhesion as well as content resistance are improved by using unsaturated graft polyolefin carboxylate resin.

### EXAMPLES

The copper member for battery, the battery using the same, and the packaging material of the present invention will be described by means of examples.

In the following example and comparative example, the laminate forming the outer shell has a configuration comprising ON25/DL/AL40/PPa15/CPP30 (where, ON: biaxially oriented nylon film, DL: dry laminate, AL: aluminum foil, PPa: unsaturated graft denatured polypropylene carboxylate, and CPP: polypropylene; the figures following the abbreviations represent layer thickness).

PPa 100 μm was employed as an adhesive film present between the outer shell and the terminal.

### Example 1

A terminal 1 was made of copper, and a terminal 2 was made of aluminum, with a width of 4 mm and a thickness of 100 μm.

The terminal 1 was alkali-degreased, water-rinsed. It was chromate-pickled and water-rinsed again. Then, a composite covering layer containing the following materials with respective deposit weights was formed:

| | | | |
|---|---|---|---|
| 1) | Aminated phenol polymer: | 10 | mg/m² |
| 2) | Chromium deposit weight: | 5 | mg/m² |
| 3) | Phosphorus deposit weight: | 1 | mg/m² |

A similar composite covering layer was formed also on the terminal 2, with the following deposit weights:

| | | | |
|---|---|---|---|
| 1) | Aminated phenol polymer: | 10 | mg/m² |
| 2) | Chromium deposit weight: | 2 | mg/m² |
| 3) | Phosphorus deposit weight: | 1.5 | mg/m² |

The resultant tabs 1 and 2 were attached to the battery to form a battery main body. The battery main body thus obtained was inserted into a pillow-type outer shell comprising the above-mentioned laminate. A side not containing a terminal was left unsealed, and an adhesive film was placed on a heat sealing section of the terminal for heat sealing to obtain a battery to be tested.

### Comparative Example 1

A battery to be tested was prepared under the same conditions as in Example 1 except that the terminal 1 (copper) was left untreated.

<Evaluation>

A storage test was carried out at 85° C. for 30 days by quietly placing the thus obtained battery to be tested with the tabs section downward, introducing electrolyte (1 mol lithium phosphate hexafluoride was added to a solution of ethylenecarbonate:diethylcarbonate:dimethylcarbonate=1:1:1) in an amount of 5 g from the above-mentioned non-sealed portion into the outer shell, and hermetically sealing the non-sealed portion. Presence and position of leakage of the contents from the tabs section was checked with naked eye.

<Result>

Example showed no leakage, suggesting a satisfactory sealing property of both copper of the terminal 1 and aluminum of the terminal 2. For Comparative Example 1, liquid leakage from the terminal 1 (copper) was observed in 30 of the 50 objects of test.

Advantages

When using copper foil or a copper sheet as at least one of the tabs of a battery, it is possible to prevent corrosion and dissolution on the tabs surface caused by hydrofluoric acid generated from the reaction between the electrolyte of the battery and water and to maintain battery functions for a long period of time by forming a composite covering layer after pre-treating the copper surface in accordance with the present invention.

What is claimed is:

1. A copper member for battery, having a composite covering layer comprising an aminated phenol polymer, a trivalent chromium compound and a phosphorus compound formed on the surface of a foil-shaped, sheet-shaped or plate-shaped copper member.

2. A copper member for battery according to claim 1, wherein said composite covering layer has an aminated phenol polymer deposit weight from 1 to 20 mg/m², a chromium deposit weight from 0.5 to 50 mg/m², and a phosphorus deposit weight from 0.5 to 5 mg/m².

3. A copper member for battery according to claim 1, wherein an alkaline degreasing treatment is applied to the surface of said copper member prior to forming said composite covering layer.

4. A copper member for battery according to claim 1, wherein a pickling treatment is applied to the surface of said copper member prior to forming said composite covering layer.

5. A copper member for battery according to claim 1, wherein an alkaline degreasing treatment and a pickling treatment are applied to the surface of said copper member prior to forming said composite covering layer.

6. A battery terminal comprising a copper member according to claim 1.

7. A battery, wherein at least one terminal is a battery terminal according to claim 6, having the battery and a battery packaging material for packaging a main body of the battery.
